(19) United States
(12) Patent Application Publication
(10) Pub. No.: US 2006/0276149 A1
(43) Pub. Date: Dec. 7, 2006

(54) Multi-band broadcast tuner

(75) Inventors: Michael D. Womac, McKinney, TX (US); Thomas L. Davis, Carrollton, TX (US)

Correspondence Address: BAKER BOTTS L.L.P., 2001 ROSS AVENUE, SUITE 600, DALLAS, TX, 75201-2980, US

(73) Assignee: Microtune (Texas), L.P.

(21) Appl. No.: 11/144,299

(22) Filed: Jun. 3, 2005

(51) Int. Cl. H04B 17/02; H04B 1/06; H04B 7/00

(52) U.S. Cl. 455/133; 455/277.1

(57) ABSTRACT

A system for receiving radio-frequency signals includes a first input path, a second input path, a selector, and a mixer. The first input path is capable of transmitting to the mixer a first input signal propagating in a first portion of the radio-frequency spectrum, while the second input path is capable of transmitting to the mixer a second input signal propagating in a second portion of the radio-frequency spectrum. The selector is capable of selectively coupling one of the first input path and the second input path to the mixer. Additionally, the mixer is capable of receiving an input signal and downconverting at least a portion of the input signal that is propagating within a selected frequency range. The mixer is also capable of outputting the downconverted portion of the input signal.

### TECHNICAL FIELD OF THE INVENTION

This invention relates in general to radio-frequency signal tuners and, more particularly, to a multi-band digital broadcast tuner.

### BACKGROUND OF THE INVENTION

Developments in the communication industry over recent years have led to the introduction of portable devices that provide a wide variety of communication services. Combined with increasing customer expectations for service quality, this trend has caused an increased demand for devices that provide substantial signal processing power but that are also small and require only a limited amount of power to operate. For example, the introduction of digital video standards for portable devices, such as Digital Video Broadcast-Handheld (DVB-H), has led to the development of handheld devices that can receive and display digital video and audio signals. However, the reception and processing of broadcast digital video and broadcast digital audio signals in conventional handheld devices may require a sizeable collection of circuits and/or components. These components can require significant amounts of space, dissipate a substantial amount of power, and add excessive complexity to the handheld device.

### SUMMARY OF THE INVENTION

In accordance with the present invention, the disadvantages and problems associated with signal tuners have been substantially reduced or eliminated. In particular, a multi-band broadcast tuner is provided.

In accordance with one embodiment of the present invention, a system for receiving radio-frequency signals includes a first input path, a second input path, a selector, and a mixer. The first input path is capable of transmitting to the mixer a first input signal propagating in a first portion of the radio-frequency spectrum, while the second input path is capable of transmitting to the mixer a second input signal propagating in a second portion of the radio-frequency spectrum. The selector is capable of selectively coupling one of the first input path and the second input path to the mixer. Additionally, the mixer is capable of receiving an input signal and downconverting at least a portion of the input signal that is propagating within a selected frequency range. The mixer is also capable of outputting the downconverted portion of the input signal.

Important technical advantages of certain embodiments of the present invention include power saving benefits, space-saving packaging, and greater operational flexibility. Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a digital display device according to a particular embodiment of the present invention;

FIG. 2 illustrates a tuner utilized by particular embodiments of the digital display device shown in FIG. 1;

FIGS. 3A-3E are frequency-domain representations of example signals during various stages of processing by the tuner show in FIG. 2; and

FIGS. 4A-4D are time-domain representations of example signals output by a particular embodiment of the tuner shown in FIG. 2.

### DETAILED DESCRIPTION OF THE INVENTION

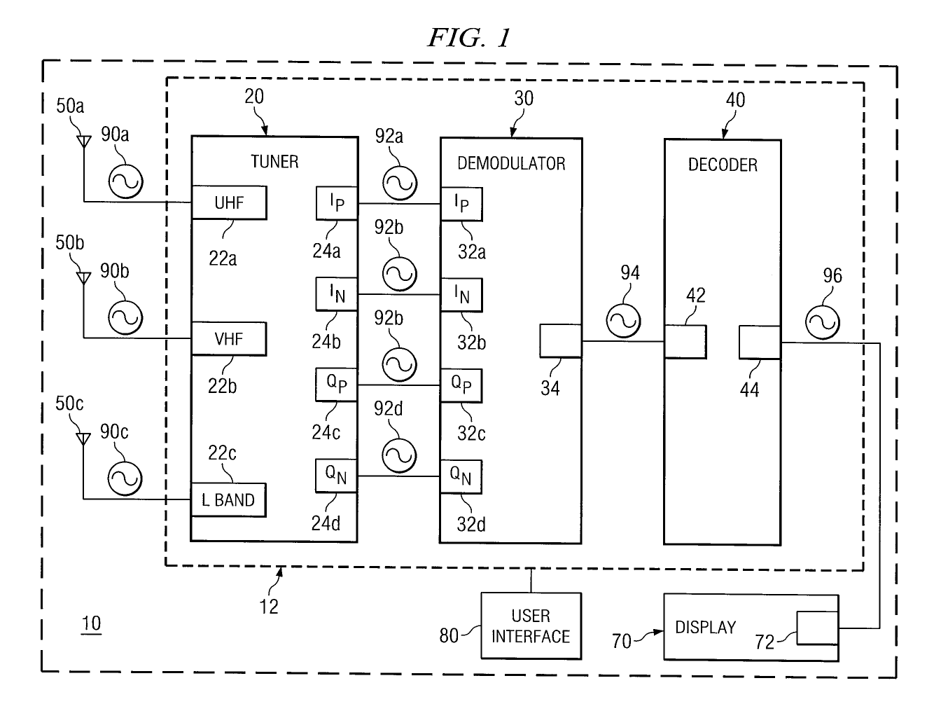

FIG. 1 illustrates a system 10 that includes a tuner 20, a demodulator 30, a decoder 30, a display 70, a switching element 60, and a plurality of antennas 50a-c. System 10 receives radio-frequency (RF) signals, processes these signals, and displays information included in the signals to a user of system 10. Although the description below focuses on an embodiment of system 10 in which system 10 represents a portable device such as, for example, a mobile telephone, a personal digital assistant (PDA), or a portable television, system 10 may represent any appropriate device suitable to receive video signals.

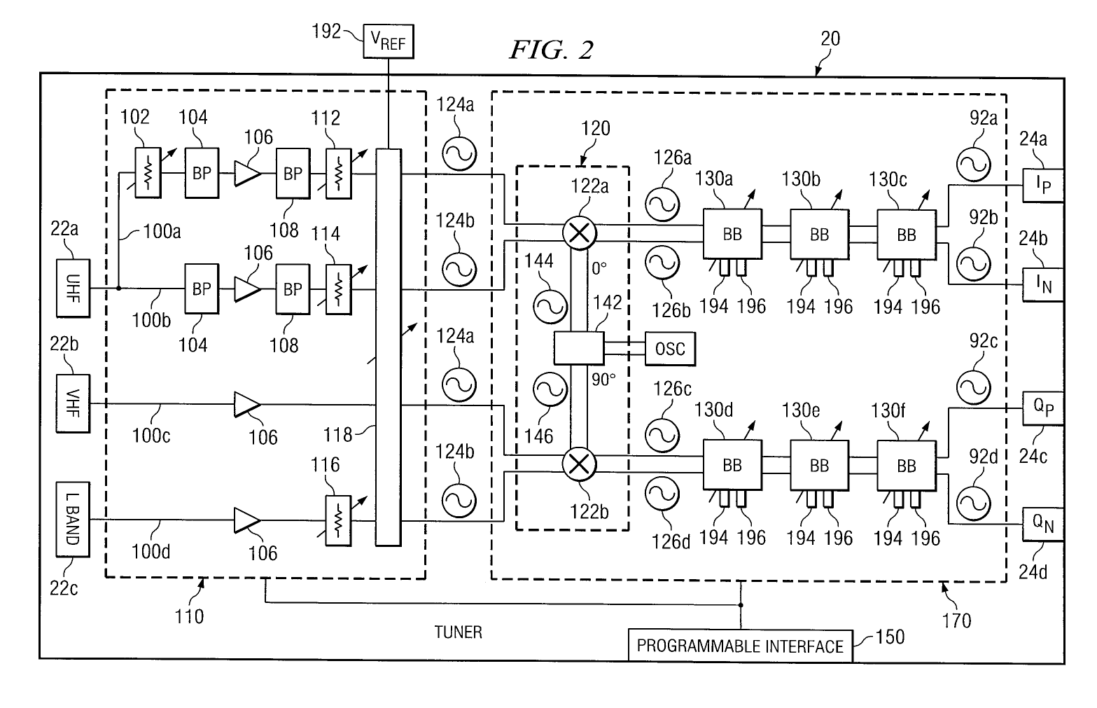

Tuner 20 receives video, audio, and/or any other appropriate form of radio-frequency (RF) signals, including any suitable form of digitally-encoded RF signals, from antennas 50 and isolates, within these signals, the portions of these signals that are being transmitted within a particular frequency range or “channel.” Tuner 20 then outputs the isolated portions to demodulator 30 through one or more tuner output ports 24 as tuned signals 92. In particular embodiments, tuner 20 receives video signals from antennas 50 as single-ended input signals and outputs differential quadrature signals to demodulator 30. In particular embodiments, tuner 20 represents a single integrated circuit. Tuner 20 may however represent any appropriate combination of hardware and/or software suitable to provide the described functionality. The contents and operation of a particular embodiment of tuner 20 are described in greater detail below with respect to FIG. 2.

Demodulator 30 receives, at demodulator input ports 32, signals output by tuner 20 and extracts information from these signals based on the modulation scheme for which system 10 is configured. Demodulator 30 then outputs the extracted information to decoder 40 through demodulator output port 34 as encoded data 94. In particular embodiments, demodulator 30 is configured to demodulate information modulated using code orthogonal frequency-division multiplexing (COFDM). Demodulator 30 may however be configured to demodulate information modulated using any appropriate technique. Demodulator 30 may represent any appropriate combination of hardware and/or software suitable to provide the described functionality.

Decoder 40 decodes information received from demodulator 30 based on the coding scheme for which system 10 is configured. Decoder 40 then outputs decoded data 96 to display 70. In particular embodiments, decoder 40 is configured to decode information encoded using the Motion Picture Experts Group-2 (“MPEG-2”) standard. Decoder 40 may however be configured to decode information encoded using any appropriate technique. Decoder 40 may represent any appropriate combination of hardware and/or software suitable to provide the described functionality.

Antennas 50 receive radio-frequency signals from terrestrial and/or satellite sources and transmit these signals to inputs of tuner 20 as single-ended inputs. Antennas 50 may represent and/or include any appropriate components to receive radio-frequency signals. In particular embodiments, system 10 is configured to receive signals in multiple bands of the radio-frequency spectrum, and display device may include a separate antenna 50 for each frequency band system 10 is capable of receiving. Although the description below focuses on embodiments of system 10 in which tuner 20 receives input signals 90 through antennas 50, particular embodiments of system may omit antennas 50. In such embodiments, tuner 20 may receive input signals 90 from other components of system 10 or from external cable transmission systems.

In the illustrated embodiment, system 10 includes an ultra high frequency (UHF) antenna 50a through which system 10 receives signals having a frequency within an appropriate portion of the UHF spectrum, a very high frequency (VHF) antenna 50b through which system 10 receives signals having a frequency within an appropriate portion of the VHF spectrum, and an L-band antenna 50 through which system 10 receives signals having a frequency within an appropriate portion of the L-Band. For example, particular embodiments of system 10 may be configured to receive signals within the 470 MHz to 2 GHz sub-band of the UHF spectrum on UHF antenna 50a, to receive signals within the 150 MHz to 260 MHz sub-band of the VHF spectrum on VHF antenna 50b, and to receive signals within the 1.5 to 1.6 GHz sub-band of the L-Band spectrum on L-Band antenna 50c. As a result, in particular embodiments, tuner 20 may be operable to receive signals within a wide sub-band from particular antennas 50 and within a narrow sub-band from the same or other antennas 50. Moreover, as described in greater detail below, tuner 20 may be capable of tuning across both the wide sub-bands and narrow sub-bands using a common mixer and/or other shared components.

Although FIG. 1, illustrates a particular embodiment of system 10 that includes a particular number of antennas 50 capable of receiving signals transmitted over particular portions of the radio-frequency spectrum, system 10 may include any appropriate number of antennas 50, with each capable of receiving signals transmitted over any appropriate portion of the radio-frequency spectrum. Moreover, in particular embodiments of system 10, tuner 20 may receive input signals 90 propagating within multiple bands of the radio-frequency spectrum at a single antenna 50.

Display 70 displays video and/or audio information received by system 10 to a user of system 10. For the purposes of this description and the claims that follow, display 70 may display information to the user by outputting audio, video, and/or text of any appropriate form to the user. Display 70 may represent and/or include any suitable hardware and/or software to provide the displayed information to the user. Display 70 may include a light-emitting diode (LED) display, a liquid crystal display (LCD), a speaker, and/or any other components appropriate based on the type of information system 10 is configured to receive and/or display.

User interface 80 supports interaction between the user and system 10. For example, in particular embodiments, user interface 80 may include suitable components to allow the user to select a radio or television channel to display. System 10 may include buttons, switches, a keypad, a dial, and/or any other appropriate components to allow the user to control operation of system 10. As shown by dotted-line box 12, user interface 80 may be configured to provide control signals to any or all of tuner 20, demodulator 30, and decoder 40, and these control signals may be propagated between the components in any appropriate manner. For example, in particular embodiments, user interface 80 communicates to demodulator 30 a channel selected by a user of system 10. Demodulator 30 may then indicate the selected channel to tuner 20.

In operation, system 10 receives input signals 90 from terrestrial or satellite sources at antennas 50, and antennas 50 transmit these input signals 90 to tuner 20. Tuner 20 receives input signals 90 from antennas 50 as single-ended signals at tuner input ports 22. Because tuner 20 receives inputs from antennas 50 as single-ended signals, certain components, such as a balun, may be omitted from system 10 that might be necessary or preferable if tuner 20 was limited to receiving input signals 90 as differential signals. As a result, tuner 20 and/or system 10 may be able to operate with fewer components, thereby reducing the size of system 10. Additionally, use of single-ended inputs may allow lower noise figures to be achieved, improving performance of particular embodiments of system 10 when signal reception is weak.

As described in greater detail below with respect to FIG. 2, the single-ended input signals 90 received by tuner 20 are then passed through a common set of mixers in tuner 20 that are shared by all of the antennas 50. Because the tuner 20 utilizes a common set of mixers for the multiple antennas 50, the size of tuner 20 and/or system 10 in particular embodiments may be further reduced. Based on a frequency or frequency range (referred to here as a “channel”) input by the user, tuner 20 selects one of input signals 90a-c and isolates components of the selected input signal 90 having the relevant frequency or within the relevant channel. Tuner 20 then outputs the isolated components of the selected input signal 90 as two differential outputs at output ports 24a-d.

More specifically, in the illustrated embodiment, tuner 20 generates output signals that include an in-phase portion of the selected frequency component or channel (indicated in FIG. 1 by the “I_{P}” label on tuner output port 24a), a quadrature portion of the selected frequency component or channel (indicated in FIG. 1 by the “Q_{P}” label on tuner output port 24c), and complements of both the in-phase and imaginary portions (represented by the “I_{N}” and “Q_{N}” labels on tuner output ports 24b and 24d, respectively). These signals are output as tuned signals 92a-d.

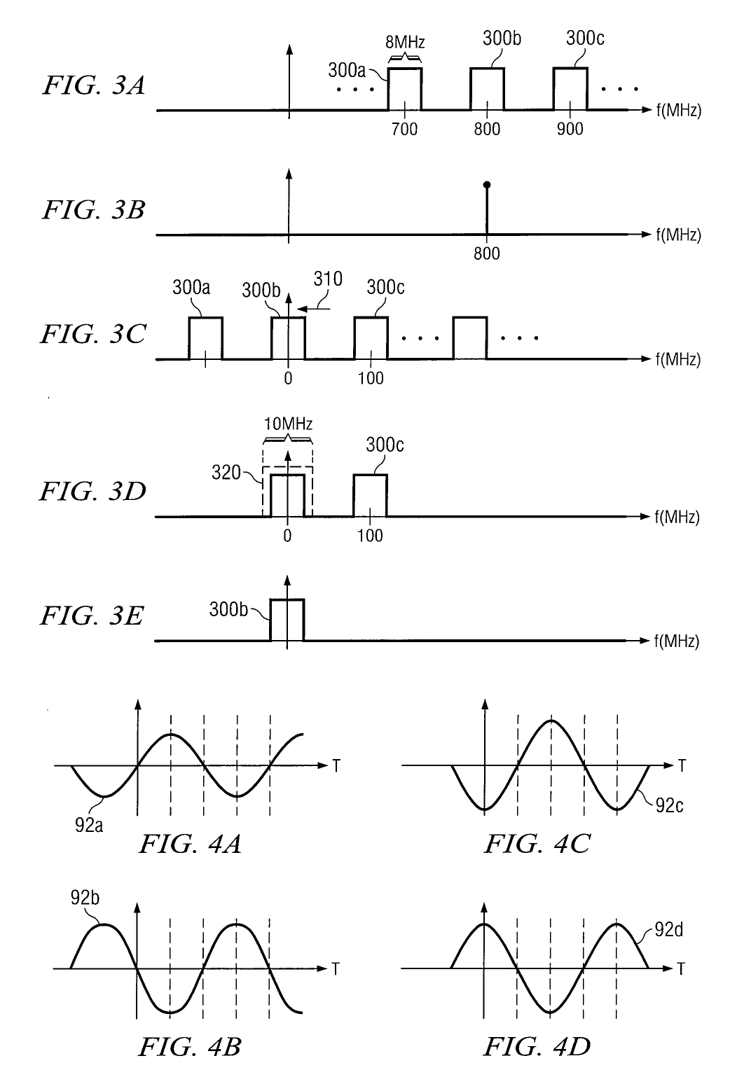

Use of differential output signals may allow tuner 20 to be utilized with many commonly-available configurations of demodulator 30 without the addition of components to convert a single-ended output of tuner 20 to the differential signal appropriate for use with such demodulators 30. As a result, the size of system 10 in particular embodiments may be even further reduced without sacrificing compatibility between tuner 20 and commonly-available demodulators 30. FIGS. 3A-3D illustrates example output signals generated by a particular embodiment of tuner 20.

Demodulator 30 receives the tuned signals 92 output by tuner 20 and demodulates these signals to produce an encoded data 94. In particular embodiments, demodulator 30 receives tuned signals 92a-d as two pairs of differential signals and independently demodulates the information transmitted in the two differential pairs. Demodulator 30 then combines the demodulated information form the two differential pairs to form encoded data 94.

Decoder 40 decodes encoded data 94 output by demodulator 30 to produce decoded data 96 in a form that can be displayed by display 70. After decoding encoded data 94, decoder 40 transmits decoded data 96 to display 70. In particular embodiments, decoder 40 may also perform digital-to-analog conversion on decoded data 96 before transmitting decoded data 96 to display 70. Display 70 then displays decoded data 96 to the user. As noted above, display 70 may display decoded data 96 by generating any appropriate combination of video, audio, and or text information for the user based on decoded data 96 and/or information included in decoded data 96.

Using user interface 80, the user may change the selected frequency or channel displayed by system 10. For example, user interface 80 may include a dial that the user can operate to change the frequency or channel displayed by system 10. In response, tuner 20 may begin isolating the newly-selected frequency or channel and may output components of the relevant input signal 90 having the newly-selected frequency or within the newly-selected channel. If the newly selected frequency or channel is on a different band (and, thus, is received on a different antenna 50), tuner 20 may also select a different input signal 90 to tune. User interface 80 may also include a power switch, volume control, and/or other components to allow the user to control operation of system 10.

Because tuner 20 is capable of receiving input signals from antennas 50 as single-ended inputs and outputting differential outputs, tuner 20 may be capable of operating with commonly-available antennas 50 and demodulators 30 while limiting the number of additional components needed to interface tuner 20 with antennas 50 and demodulator 30. Additionally, as described further below, the use of a common tuner 20 for the multiple antennas 50 connected to system 10 may result in a system 10 with fewer components and or a smaller tuner 20. As a result, the inclusion of particular embodiments of tuner 20 in display devices 10 may provide several advantages.

FIG. 2 illustrates the contents and operation of a particular embodiment of tuner 20. As shown in FIG. 2, tuner 20 includes radio-frequency (RF) stage 110, baseband stage 170, and programmable interface 150. Additionally, as shown, RF stage 110 includes multiple paths 100 connecting tuner input ports 22 to signal converter 118, while baseband stage 170 includes quadrature mixer 120, baseband filters 130, oscillator 140, and quadrature generator 142. Tuner 20 receives single-ended inputs from multiple antennas 50 at input ports 22 and generates a differential output signal based on a particular frequency component of the received input signal. Tuner 20 then transmits the output signal to demodulator 30 through output ports 24. In the illustrated embodiment, tuner 20 transmits the output signal to demodulator 30 as a differential signal, but tuner 20 may, in general, transmit the output signal to demodulator 30 in any appropriate form.

RF stage 110 receives input signals 90 from tuner input ports 22 and processes input signals 90 to facilitate tuning of input signals 90. RF stage 110 may process input signals in any appropriate manner based on the characteristics of the input signals 90 received by tuner 20 and the configuration of mixers 122 and/or other components of tuner 20. Moreover, RF stage 110 may include any suitable components to perform the relevant processing.

In the illustrated embodiment, RF stage 110 includes a plurality of paths 100 connecting each of tuner input ports 22 to a signal converter 118. Signal converter 118 couples one of paths 100 to quadrature mixer 120 based on a frequency or channel selected by the user and/or other appropriate factors. Additionally, signal converter 118 may convert the input signals 90 received by RF stage 110 in an appropriate manner to facilitate the input of these signals to quadrature mixer 120. In particular embodiments, signal converter 118 converts single-ended input signals 90 received by tuner 20 into a differential pair of preprocessed signals 124a and 124b. Additionally, in particular embodiments, signal converter 118 may also perform voltage-to-current conversion on input signals 118 and output preprocessed signals 124 as current mode signals. Moreover, signal converter 118 may induce gain in the selected signal providing additional control over the signal strength and distortion characteristics of preprocessed signal 124.

Although FIG. 2 illustrates a particular RF stage 110 that includes a particular number and configuration of components, RF stage 110 may include any appropriate number and configuration of components based on the input signals 90 received by tuner 22 and the characteristics and capabilities of the other components of tuner 20. For example, as shown, path 100a includes a first attenuator 102, a first tunable bandpass filter 104, a low noise amplifier 106, a second tunable bandpass filter 108, and a second attenuator 102 that are connected in series and that couple tuner input port 22a to signal converter 118. Second path 100b includes a third tunable bandpass filter 112, a low noise filter 106, a second tunable bandpass filter 104, and an attenuator 102 that are connected in series and that also couple tuner input port 22a to signal converter 118. Third path 100c includes low noise amplifier 106 and couples tuner input port 22b to signal converter 118. Fourth path 100d includes a low noise amplifier 106 that couples tuner input port 22c to signal converter 118.

The presence of attenuators 102 and bandpass filters 104 and 108 in paths 100a and 100b may facilitate reception of input signals 90 across a wide sub-band through paths 100a and 100b. As a result, in particular embodiments, RF stage 110 may include one or more paths (such as paths 100a and 100b) configured for use with antennas 50 receiving signals across a wide sub-band and also one or more paths (such as 100c and 100d) configured for use with antennas 50 receiving signals across a narrow sub-band. Moreover, because of the various configurations of paths 100, tuner 20, in particular embodiments, may be capable of receiving and tuning broadband and/or narrowband input signals 90 that are transmitted over a very wide sub-band of the RF spectrum and also be capable of receiving and tuning broadband and/or narrowband input signals 90 that are received over a very narrow sub-band of the RF spectrum without substantial deterioration in performance. For example, in particular embodiments, tuner 20 may be capable of receiving and tuning signals transmitted over an approximately 1.5 GHz sub-band (from 470 MHz to 2 GHz) of the UHF band of the RF spectrum as well as receiving and tuning signals transmitted over an approximately 100 MHz sub-band (150 MHz to 260 MHz) of the VHF band of the RF spectrum without substantial deterioration of performance when tuning within either sub-band. Although these values are provided for purposes of illustration, tuner 20 may, in particular embodiments, be configured to allow tuning across any appropriately sized sub-bands of any portions of the RF spectrum.

Each of paths 100 is operable to connect a particular tuner input port 22 to signal converter 118. Moreover, in particular embodiments, multiple paths 100 may connect a particular tuner input port 22 to signal converter 118. In such embodiments, the multiple paths 100 may each provide different forms of processing to the input signals 90 received by that tuner input port 22. For example, in the illustrated embodiment, both 100a and 100b connect tuner input port 22a to signal converter 118. Based, in part, on the presence of the additional attenuator 102 in first path 100a, first path 100a, however, may be more tolerant of interference, while second path 100b may allow for more robust frequency reception. Depending on strength of signal and/or other operational considerations, the user or system 10 itself may select an appropriate one of path 100a and path 100b to provide UHF signals to mixers 122. Furthermore, as described further below, gain and attenuation elements may be distributed throughout particular paths 100 to allow tuner 20 to be configured for an optimal tradeoff between distortion and noise.

Additionally, in particular embodiments, tuner 20 may be housed in a single integrated circuit and signal converter 118 may be coupled to a single reference voltage 192 provided by components external to tuner 20 for multiple bands. In general, reference voltage 192 may be provided by any appropriate component or collection of components. In particular embodiments, reference voltage 192 is provided by a charged capacitor. In alternative embodiments, reference voltage 192 may be provided by a bandgap voltage generator.

Oscillator 140 generates a periodic signal at a tuning frequency selected by the user and provided to oscillator 140 by programmable interface 150. Additionally, although not shown in FIG. 2, oscillator 140 may, in particular embodiments, include one or more frequency dividers located near quadrature mixer 120 to adjust the frequency of the tuning signal to a frequency useable by quadrature mixer 120. Oscillator 140 may comprise all or a portion of a frequency synthesizer using a phase-locked loop (PLL). This may allow use of a PLL capable of producing tuning signals in a frequency range much higher than that of the input signals 90 received by tuner 20. In the illustrated embodiment, tuning signal 144 comprises a differential signal pair.

Quadrature generator 142 receives tuning signal 144 from oscillator 140 and induces a ninety-degree (90°) phase shift in a copy of tuning signal 144 to produce a shifted tuning signal 146. Quadrature generator 142 then outputs a copy of the original tuning signal 144 and shifted tuning signal 146 to mixers 122. Additionally, when appropriate based on the selected channel, quadrature generator 142 may act as a frequency divider to reduce the frequency of tuning signal 144 to a level appropriate to downconvert the selected channel. For example, in particular embodiments, quadrature generator 142 may be capable of dividing the frequency of tuning signal 144 output by oscillator 140 by any multiple of two from two to N (for example, in particular embodiments, N may equal 32). As a result of this flexibility, such embodiments of tuner 20 may be capable of tuning channels received in several different bands of the radio-frequency spectrum. Quadrature generator 142 may include any appropriate combination of hardware and/or software to provide the described functionality.

Quadrature mixer 120 includes in-phase mixing cell 122a and quadrature mixing cell 122b. Mixers 122 mix preprocessed signals 124 output by RF stage 110 with a tuning signal 144 generated by oscillator 140 to produce a downconverted version of a selected input signal 90 received by tuner 20. As discussed further below, FIG. 3E illustrates a frequency-domain representation of an example output for mixers 122, based on the input illustrated in FIG. 3C. Mixers 122 may include any appropriate combination of software and/or hardware suitable to provide the described functionality.

Baseband filters 130a-c and 130d-f receive downconverted input signals from mixers 122. Baseband filters 130 filter out high-frequency components of the downconverted signal to produce an output that includes the component of the selected input signal 90 that was transmitted at the desired reception frequency. In the illustrated embodiment, baseband filters 130 each provide this output as a pair of differential tuned signals 92. In particular embodiments, baseband filters 130 may be configured to exhibit a passband that is sized based on the minimum channel-spacing used in the signals received at antennas 50. In general, however, baseband filters 130 may include any appropriate combination of hardware and/or software suitable to provide the described functionality. In particular embodiments, it may be desirable, for purposes of optimizing the range dynamic range of output signals 92, to configure baseband filters 130 such that the noise induced in downconverted signals 126a-d passing through baseband filters 130 is independent of the gain induced by baseband filters 130 and/or of the magnitude of downconverted signals 126.

Additionally, particular embodiments of tuner 20 may facilitate more granular control of baseband filters 130 to provide better noise and linearity characteristics in output signals 92. For example, in the illustrated embodiment, baseband filters 130 may each be associated with a frequency control module 194 and a gain control module 196. Each frequency control module 194 may be used to adjust the cutoff frequency of the associated baseband filter 130 independently of the cutoff frequency of the remaining baseband filters 130. Similarly, each gain control module 196 may be used to adjust the variable gain of the associated baseband filter 130 independently of the variable gain set for the remaining baseband filters 130. As a result of these independent control features, may be able to fine-tune the gain and frequency characteristics of output signals 92. For example, in particular embodiments, the gains induced by baseband filters 130a-c and 130d-f do not impact noise characteristics of output signals 92 in a uniform manner. As a result, in such embodiments, tuner 20 may optimize noise reduction by reducing the gain induced by baseband filters 130c and 130f as much as possible, and then proceeding to reduce the gain induced by baseband filters 130b and 130e if more noise reduction is needed. Frequency control module 194 and gain control module 196 may represent any appropriate combination of hardware and/or software operable to provide the described functionality.

Programmable interface 150 allows a user or other elements of system 10 to configure operation of tuner 20. In particular embodiments, programmable interface 150 represents a serial digital bus and control logic capable of adjusting operation of various components of tuner 20 based on control information transmitted on the serial digital bus. In general, however, programmable interface 150 may include any appropriate collection of hardware and/or software to allow tuner 20 to receive control information from the user or other elements of system 10. In particular embodiments, programmable interface 150 may be configured to communicate with portions of user interface 80. For example, programmable interface 150 may receive, from user interface 80, information specifying a frequency or channel selected by the user. Additionally, programmable interface 150 may receive information from other elements of system 10, such as demodulator 30, to allow that device to set power-consumption settings and other operational parameters of system 10. Programmable interface 150 may be configured to provide control signals to any or all of the elements of RF stage 110 and baseband stage 170, and these control signals may be propagated between and within the two stages in any appropriate manner.

In operation, tuner 20 receives input signals 90 from antennas 50 as single-ended signals at input ports 22. Input signals 90 are transmitted to signal converter 118 over paths 100. Paths 100, in particular embodiments, may include a number of distributed gain and attenuation elements. Because the impact of signal gain and attenuation may vary at different locations along paths 100, the distribution of gain and attenuation elements along paths 100 may provide system 10 greater ability to achieve an optimal balancing between signal strength and distortion.

For example, in the illustrated embodiment, path 100a includes variable attenuator 102, bandpass filter 104, low-noise amplifier 106, bandpass filter 108 and attenuator 112 coupled in series. In particular embodiments, bandpass filters 104 and 108 and low-noise amplifier 106 may each be capable of inducing a variable gain in signals they receive, and attenuators 102 and 112 may be capable of inducing a variable attenuation in signals they receive.

As a result, system 10 may be able to achieve an optimal tradeoff between distortion and signal strength by selectively configuring the variable components along a particular path 100. For example, in particular embodiments, if distortion occurs in output signals 92a, attenuating the associated input signal 90 at attenuator 112 (e.g. by increasing the attenuation induced by variable attenuator 112) may result in a greater reduction in distortion for a given reduction in signal strength than attenuating input signal 90 at attenuator 102 due to the proximity of attenuator 112 to signal converter 118. Thus, the finer control facilitated by distributing gain and attenuation elements at multiple locations along particular paths 100 may facilitate improved control of tuner 20.

Based on input received from programmable interface 150, signal converter 118 selects a particular path 100 to output. Depending on the configuration of system 10, signal converter 118 may, by selecting a particular path 100 to output, select the antenna 50 from which tuner 20 receives the input signal. For example, in the illustrated embodiment, signal converter 118 may, by selecting between paths 100b-d, select between input signals 90 received from antennas 50a-c respectively.

Additionally, in particular embodiments, multiple paths 100 may couple a particular antenna 50 to signal converter 118. In such embodiments, signal converter 118 may also, by selecting a particular path 100, select the processing to be performed to the selected input signal 90. For example, in the illustrated embodiment, both paths 100a and 100b couple UHF antenna 50a to signal converter 118. However, as a result of the inclusion of attenuator 102 prior to bandpass filter 104, path 100a may represent, by comparison to path 100b, a low-distortion path that exhibits better linearity characteristics than path 100b. Similarly, as a result of the absence of a comparable attenuator before bandpass filter 104 in path 100b, path 100b may represent, by comparison to path 100a, a high-sensitivity path to facilitate tuning of weaker signals in low-noise settings. Thus, signal converter 118 may also, by selecting between paths 100, select the conditioning to be performed on the relevant input signal 90. As a result, tuner 20 may be reconfigured dynamically to adjust to changes in operating conditions or performance requirements.

Furthermore, in particular embodiments, signal converter 118 may also convert the selected input signal 90 from a single-ended signal to a differential signal pair. Signal converter 118 than outputs the selected signal, which is shown in FIG. 2 as a pair of preprocessed signals 124, to quadrature mixer 120. In particular embodiments, RF stage 110 also serves as a low-noise amplifier amplifying the received input signals 90 to a level sufficient for use by tuner 20. By amplifying input signals 90 prior to voltage to current conversion, particular embodiments of RF stage 110 may limit the current consumption by tuner 20. Moreover, by amplifying input signals 90, prior to converting them from single-ended signals to differential signal pairs, particular embodiments of RF stage 110 may produce improved noise figures. Additionally, by converting input signals 90 to differential signals before transmitting input signals 90 to quadrature mixer 120, tuner 20 may achieve better even-order distortion performance.

Oscillator 140 provides mixers 122a and 122b with a tuning signal 144 having a frequency set by the user using user interface 80. Based on tuning signal 144, quadrature mixer 120 downconverts a particular frequency component or channel within preprocessed signals 124 so that the relevant frequency or channel possesses a lower center frequency. More specifically, mixers 122a and 122b downconvert the relevant frequency component or channel so that the relevant frequency component or channel is centered at the desired baseband frequency. In particular embodiments, this frequency may be substantially near 1 Hz. After downconversion, preprocessed signals 124 are output by mixers 122a and 122b as downconverted signals 126. FIG. 3C illustrates an example downconverted signal 126 produced in a particular embodiment of tuner 20.

After downconverted signals 126 are output by mixers 122, baseband filters 130 filter out all frequency components outside a particular desired passband, thereby producing tuned signals 92. As noted above, these tuned signals 92 may, in particular embodiments, represent a pair of quadrature, differential signals. FIG. 3D illustrates an example of this filtering process and FIG. 3E illustrates the tuned signals 92 resulting from this example.

In particular embodiments, each baseband filter 130 is additionally capable of inducing a variable gain in downconverted signals 126. As a result, tuner 20 may be configured to further reduce noise in output signals 92 by adjusting the gain induced by baseband filters 130. Furthermore, because particular embodiments of tuner 20 include multiple baseband filters 130 at the output of each mixing cell 122, baseband stage 170 may provide finer control of noise by allowing distributed gain control similar to that described with respect to RF stage 110.

Additionally, in particular embodiments, programmable interface 150 may, in addition to receiving an indication of the selected frequency or channel, may be capable of receiving other inputs that affect operation of tuner 20. As one example, in particular embodiments, programmable interface 150 may receive power parameters that specify a power-consumption mode or other power-related settings for tuner 20. Programmable interface 150 may, in response to receiving such power parameters, power down one or more elements of tuner 20 and/or otherwise adjust aspects of the operation of tuner 20 related to power-consumption based on the power parameters received by programmable interface 150.

As another example, in particular embodiments, programmable interface 150 may receive linearity parameters that specify linearity settings for tuner 20. Programmable interface 150 may, in response to receiving such linearity parameters, vary the gain or attenuation induced by amplifiers 106, attenuators 102, 112, 114, and 116, or baseband filters 130 and/or otherwise adjust aspects of the operation of tuner 20 related to linearity based on the received linearity parameters. Similarly, in particular embodiments, programmable interface 150 may receive noise parameters that specify noise settings for tuner 20. Programmable interface 150 may, in response to receiving such noise parameters, adjust the operation of amplifiers 106, bandpass filters 104, bandpass filters 108, baseband filters 130, and/or otherwise adjust aspects of the operation of tuner 20 related to noise based on the noise parameters received by programmable interface 150.

Thus, particular embodiments of tuner 20 may amplify single-ended, voltage mode input signals 90 before converting these input signals to differential, current mode preprocessed signals 124, thereby providing better noise characteristics and consuming less current than if single-ended-to-differential and/or voltage-to-current conversion were done prior to amplification. Additionally, particular embodiments of tuner 20 provide multiple signals paths 100 from input ports 22 to quadrature mixer 120 that include different configurations of filtering and amplification, allowing both signals received across a wide sub-band and those receive across a narrow sub-band to be tuned by mixer 120 without substantial deterioration in performance. Furthermore, the distributed gain and attenuation elements throughout tuner 20 provide greater control over noise and distortion in particular embodiments of tuner 20. Also, the inclusion of a programmable interface may allow simplified interaction with and control of tuner 20. As a result, particular embodiments of tuner 20 may provide a number of operational benefits. Although a number of benefits are described, particular embodiments of tuner 20 may provide some, all, or none of these benefits.

Thus, particular embodiments of tuner 20 may be capable of tuning signals received in multiple different bands using a common quadrature mixer 120. Additionally, particular embodiments of tuner 20 may be able to generate quadrature, differential tuned signals 92 from single-ended input signals 90. As a result, tuner 20 may minimize the number of external components that may be required in system 10 to allow tuner 20 to operate with common configurations of antennas 50 and demodulator 30. Consequently, particular embodiments of tuner 20 may provide multiple benefits when utilized in system 10. Nonetheless, a particular embodiment of tuner 20 may include some, none, or all of these benefits.

FIGS. 3A-3E illustrate frequency-domain representations of various signals associated with the operation of tuner 20 during the tuning of a particular example input signal. In particular FIGS. 3A-3E illustrate the tuning of the example preprocessed signal 124 illustrated in FIG. 3A, based on a tuning frequency input by a user. In the illustrated examples, the user is assumed to have selected a tuning frequency of 800 MHz.

FIG. 3A illustrates an example of a preprocessed signal 124 generated by RF stage 110 from an example input signal 90. This example preprocessed signal 124 includes information transmitted on a plurality of different channels 300, each channel 300 including a particular range of frequencies. More specifically, in the illustrated embodiment input signals 90 include information transmitted in a plurality of 8 MHz-wide channels 300 spaced 100 MHz apart, as shown in FIG. 3A. As a result, the selected tuning frequency corresponds to channel 300b.

FIG. 3B illustrates a tuning signal 144 generated by oscillator 140 based on a tuning frequency selected by the user. As shown in FIG. 2, this tuning signal 144 is transmitted to mixers 122. As noted above, the user is assumed to have selected a tuning frequency of 800 MHz in the illustrated examples.

FIG. 3C illustrates the downconverted signal 126 output by mixing cell 122a in response to receiving the preprocessed signal 124 illustrated in FIG. 3A and the tuning signal illustrated in FIG. 3B. As suggested by arrow 310, the downconversion performed by mixing cell 122a results in the shifting of the relevant channel 300b to a desired baseband frequency. In the illustrated embodiment, this frequency is substantially near 1 Hz.

FIG. 3D illustrates operation of baseband filters 130a-c collectively in filtering the downconverted signal 126 illustrated in FIG. 3C. In the illustrated example, baseband filter 130 is assumed to have a passband that is 10 MHz wide and centered within the desired baseband frequency. This is shown in FIG. 3D by the dotted-line box 320. Although not shown in FIG. 3D baseband filters 130a-c may induce gain in the signal

FIG. 3E illustrates a tuned signal 92a output by baseband filter 130a as a result of the operation illustrated in FIG. 3D. As shown, baseband filter 130a blocks all frequency components of downconverted signal 126 that are outside the 10 MHz passband centered within the desired baseband frequency. Thus, in this illustrated example, the tuned signal 92a output by baseband filter 130 includes only the relevant channel 300b selected by the user.

FIGS. 4A-4D illustrate time-domain representations of example quadrature, differential tuned signals 92 output by baseband filters 130a-c and 130d-f for an example sine-wave RF input signal 90. More specifically, FIGS. 4B-4D illustrate the quadrature tuned signals 92b-d that would be output by a particular embodiment of tuner 20 along with the example tuned output signal 92a shown in FIG. 4A. In particular, FIG. 4B illustrates an example tuned signal 92b that would be output at tuner output port 24b while the tuned signal 92a shown in FIG. 4A is output at tuner output port 24a. In particular embodiments, tuned signal 92b is the complement of tuned signal 92a, as shown in the example of FIG. 4B.

FIG. 4C illustrates an example tuned signal 92c that would be output at output port 24c while the tuned signal 92a shown in FIG. 4A is output at output port 24a. In particular embodiments, such as the one represented by FIG. 4C, tuned signal 92c is a phase-shifted version of tuned signal 92a that has been shifted by ninety degrees (90°). FIG. 4D illustrates an example tuned signal 92d that would be output at output port 24d while the example tuned signal 92a shown in FIG. 4A is output at output port 24a. As shown, tuned signal 92d is the complement of tuned signal 92c.

Thus, as shown by FIGS. 4A-4D, particular embodiments of tuner 20 may output tuned signals 92 as two differential pairs of quadrature signals. As a result, tuner 20 outputs the relevant information in a format accepted by many commonly-available demodulators. Particular embodiments may therefore provide compatibility benefits when used in system 10.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for receiving radio-frequency signals comprising:
a first input path operable to transmit to an input of a mixer a first input signal associated with a first portion of a radio-frequency spectrum;
a second input path operable to transmit to the input of the mixer a second input signal associated with a second portion of the radio-frequency spectrum, wherein the first portion is greater than the second portion;
a selector operable to selectively couple one of the first input path and the second input path to the input of the mixer; and
the mixer operable to:
receive a selected one of the first input signal and the second input signal;
downconvert at least a portion of the selected input signal; and
output the downconverted portion of the selected input signal.

2. The system of claim 1, wherein the first input signal and the second input signal comprise broadband data signals.

3. The system of claim 1, comprising:
a first antenna coupled to the first input path and operable to receive signals transmitted in the first portion of the radio-frequency spectrum; and
a second antenna coupled to the second input path and operable to receive signals transmitted in the second portion of the radio-frequency spectrum.

4. The system of claim 1, further comprising:
an antenna coupled to the first input path and coupled to the second input path and operable to:
receive signals transmitted in the first portion of the radio-frequency spectrum; and
receive signals transmitted in the second portion of the radio-frequency spectrum.

5. The system of claim 1, wherein the first portion of the radio-frequency spectrum comprises at least a portion of an ultra-high frequency (UHF) band.

6. The system of claim 1, wherein the second portion of the radio-frequency spectrum comprises at least a portion of a very high frequency (VHF) band.

7. The system of claim 1, wherein the second portion of the radio-frequency spectrum comprises at least a portion of an L-Band.

8. The system of claim 1, wherein at least one of the first input signal and the second input signal comprises digital broadcast television signals formatted in accordance with a Digital Video Broadcasting-Handheld (DVB-H) standard.

9. The system of claim 1, wherein:
the first input path is operable to receive the first input signal by receiving a first single-ended input signal;
the second input path is operable to receive the second input signal by receiving a second single-ended input signal; and
the selector comprises a signal converter operable to convert a selected one of the first single-ended input signal and the second single-ended input signal to a differential signal and to transmit the differential signal to the input of the mixer.

10. The system of claim 9, wherein:
the first input path is operable to amplify the first single-ended input signal;
the second input path is operable to amplify the second single-ended input signal; and
the signal converter is operable to convert the selected one of the first amplified single-ended input signal and the second amplified single-ended input signal to a differential signal.

11. The system of claim 1, wherein the first input path is operable to receive the first input signal by receiving a first voltage mode input signal and wherein the second input path is operable to receive the second input signal by receiving a second voltage mode input signal, and wherein the selector comprises a signal converter operable to convert a selected one of the first voltage mode input signal and the second voltage mode input signal to a current mode signal and to transmit the current mode signal to the input of the mixer.

12. The system of claim 1, wherein the mixer comprises a quadrature mixer operable to output the downconverted portion of the selected input signal by outputting the downconverted portion in an in-phase differential signal and a quadrature differential signal.

13. The system of claim 1, comprising:
a third input path operable to selectively couple to the input of the mixer the first input signal, wherein the third input path comprises a high-linearity path, and wherein the first input path comprises a low-noise path, and wherein the selector is operable to couple one of the first input path and the third input path to the input of the mixer, based at least in part upon a characteristic of the first input signal.

14. The system of claim 13, wherein:
the first input path is further operable to amplify the first input signal and to couple the amplified input signal to the input of the mixer; and
the third input path is further operable to:
attenuate the first input signal;
amplify the attenuated input signal subsequent to attenuating the first input signal; and
couple the amplified attenuated input signal to the input of the mixer.

15. The system of claim 14, wherein the first input path comprises:
a first variable attenuator operable to receive the first input signal and to attenuate the first input signal by a variable amount;
a first tunable bandpass filter operable to attenuate a portion of an output of the first variable attenuator that is outside a variable passband associated with the first tunable bandpass filter;
a first amplifier operable to amplify an output of the first tunable bandpass filter;
a second tunable bandpass filter operable to attenuate a portion of an output of the amplifier that is outside a variable passband associated with the second tunable bandpass filter; and
a second variable attenuator operable to attenuate an output of the second tunable bandpass filter.

16. The system of claim 15, wherein the second input path comprises:
a third tunable bandpass filter operable to receive the first input signal and to attenuate a portion of the first input signal that is outside a variable passband associated with the third tunable bandpass filter;
a second amplifier operable to amplify an output of the third tunable bandpass filter;
a fourth tunable bandpass filter operable to attenuate a portion of an output of the second amplifier that is outside a variable passband associated with the fourth tunable bandpass filter; and
a third variable attenuator operable to attenuate a portion of an output of the fourth tunable bandpass filter.

17. The system of claim 1, further comprising one or more baseband filters operable to attenuate a portion of the downconverted signal that is outside a passband associated with the baseband filters.

18. The system of claim 17, wherein the one or more baseband filters comprises a plurality of baseband filters coupled in series, wherein each baseband filter is operable to induce a variable gain in the downconverted signal.

19. The system of claim 18, further comprising a plurality of gain control modules, wherein each of the gain control modules is associated with a particular baseband filter and operable to adjust the variable gain induced by the associated baseband filter independently of the variable gains induced by a remainder of the baseband filters.

20. The system of claim 17, wherein the one or more baseband filters comprise a plurality of baseband filters and further comprising a plurality of frequency control modules, wherein each of the frequency control modules is associated with a particular baseband filter and operable to adjust a cutoff frequency of the associated baseband filter independently of cutoff frequencies of a remainder of the baseband filters.

21. The system of claim 1, further comprising one or more baseband filters operable to:
attenuate a portion of the downconverted signal that is outside a passband associated with the baseband filters; and
induce a variable gain in the downconverted signal, wherein a noise induced in the downconverted signal by the baseband filter is independent of a signal amplitude of the downconverted signal and independent of the variable gain induced by the baseband filter.

22. The system of claim 1, further comprising:
an oscillator operable to:
generate a tuning signal; and
transmit the tuning signal to the mixer; and
a programmable interface operable to:
receive information indicating the selected frequency range; and
adjust a frequency of the tuning signal generated by the oscillator; and wherein the mixer is operable to downconvert at least the portion of the input signal based on the tuning signal.

23. The system of claim 22, wherein the oscillator is further operable to transmit the tuning signal to the mixer through a frequency divider, wherein the frequency divider is operable to divide the frequency of the tuning signal by any of two or more divisors.

24. The system of claim 1, further comprising a programmable interface operable to:
receive power parameters; and
adjust the power consumption of one or more elements of the system based on the received power parameters.

25. The system of claim 1, wherein the first input path, the second input path, the selector, the mixer, and the baseband filters are formed on a single integrated circuit.

26. A system for receiving radio-frequency signals comprising:
a first antenna operable to receive signals having a frequency within a first portion of a radio-frequency spectrum;
a second antenna operable to receive signals having a frequency within a second portion of the radio-frequency spectrum;
a tuner comprising:
a first input path coupled to the first antenna operable to transmit to an input of a mixer a first input signal associated with a third portion of a radio-frequency spectrum, wherein the third portion comprises at least a portion of the first portion;
a second input path operable to transmit to the input of the mixer a second input signal associated with a fourth portion of the radio-frequency spectrum, wherein the fourth portion comprises at least a portion of the second portion, and wherein the third portion is greater than the fourth portion;
a selector operable to selectively couple one of the first input path and the second input path to the input of the mixer; and
the mixer operable to:
receive a selected one of the first input signal and the second input signal;
downconvert at least a portion of the selected input signal; and
output the downconverted portion of the selected input signal; and
a display operable to display information included in the downconverted signal.

27. The system of claim 26, further comprising a demodulator operable to demodulate the downconverted signal, and wherein the display is operable to display information included in the downconverted signal by displaying information included in the demodulated downconverted signal.

28. The system of claim 27, further comprising a decoder operable to decode information included in the demodulated downconverted signal, and wherein the display is operable to display the demodulated downconverted signal by displaying decoded information from the demodulated downconverted signal.

29. A method of receiving radio-frequency signals, comprising:
transmitting a first input signal to an input of a mixer over a first input path operable to pass input signals associated with a first portion of a radio-frequency spectrum;
transmitting a second input signal to an input of a mixer over a second input path operable to pass input signals associated with a second portion of the radio-frequency spectrum, wherein the first portion is greater than the second portion;
selectively coupling one of the first input path and the second input path to the input of the mixer;
downconverting at least a portion of the selected input signal; and
outputting the downconverted portion of the selected input signal.
